(19) United States
(12) Patent Application Publication
(10) Pub. No.: US 2014/0247733 A1
(43) Pub. Date: Sep. 4, 2014

(54) BUFFER SIZE REPORTING FOR IRAT MEASUREMENTS IN HIGH SPEED DATA NETWORKS

(71) Applicant: QUALCOMM INCORPORATED, San Diego, CA (US)

(72) Inventors: Ming Yang, San Diego, CA (US); Tom Chin, San Diego, CA (US)

(73) Assignee: QUALCOMM Incorporated, San Diego, CA (US)

(21) Appl. No.: 13/784,323

(22) Filed: Mar. 4, 2013

(51) Int. Cl. H04W 24/02

(52) U.S. Cl. CPC H04W 24/02
USPC 370/252

(57) ABSTRACT

An intelligent buffer size reporting process includes determining whether a signal strength of a first radio access technology (RAT) is below a first threshold value. A false buffer size of zero is reported when the signal strength of the first RAT is below the first threshold value for a period of time. A signal strength of a second RAT is measured using uplink timeslots resulting from the reported false buffer size of zero.

Aspects of the present disclosure relate generally to wireless communication systems, and more particularly, to an intelligent buffer size reporting method for inter radio access technology (IRAT) measurements in time division high speed uplink packet access (TD-HSUPA).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes determining whether a signal strength of a first radio access technology (RAT) is below a first threshold value. A false buffer size of zero is reported when the signal strength of the first RAT is below the first threshold value for a period of time. A signal strength of a second RAT is measured using uplink timeslots resulting from the reported false buffer size of zero.

Another aspect discloses an apparatus for wireless communication having a memory and at least one processor coupled to the memory. The processor(s) is configured to determine whether a signal strength of a first RAT is below a first threshold value. The processor(s) is also configured to report a false buffer size of zero when the signal strength of the first RAT is below the first threshold value for a period of time. Further, the processor(s) is configured to measure a signal strength of a second RAT using uplink timeslots resulting from the reported false buffer size of zero.

In another aspect an apparatus is disclosed that includes means for determining whether a signal strength of a first RAT is below a first threshold value. The apparatus also includes means for reporting a false buffer size of zero when the signal strength of the first RAT is below the first threshold value for a period of time. The apparatus also includes means for measuring a signal strength of a second RAT using uplink timeslots resulting from the reported false buffer size of zero.

Another aspect discloses a computer program product for wireless communications in a wireless network having a non-transitory computer-readable medium. The computer readable medium has non-transitory program code recorded thereon which, when executed by the processor(s), causes the processor(s) to perform operations of determining whether a signal strength of a first RAT is below a first threshold value. The processor(s) is also configured to report a false buffer size of zero when the signal strength of the first RAT is below the first threshold value for a period of time. Further, the processor(s) is configured to measure a signal strength of a second RAT using uplink timeslots resulting from the reported false buffer size of zero.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a call flow diagram illustrating the reporting of buffer size according to one aspect of the present disclosure.

FIG. 6 is a block diagram illustrating a method for reporting buffer size according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

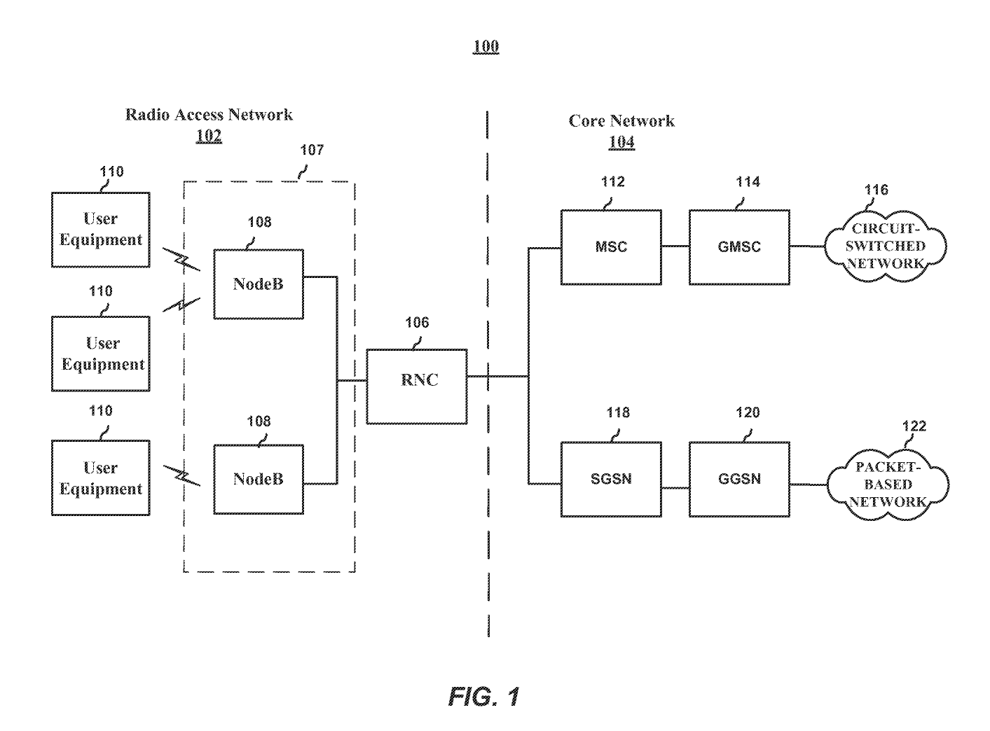

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

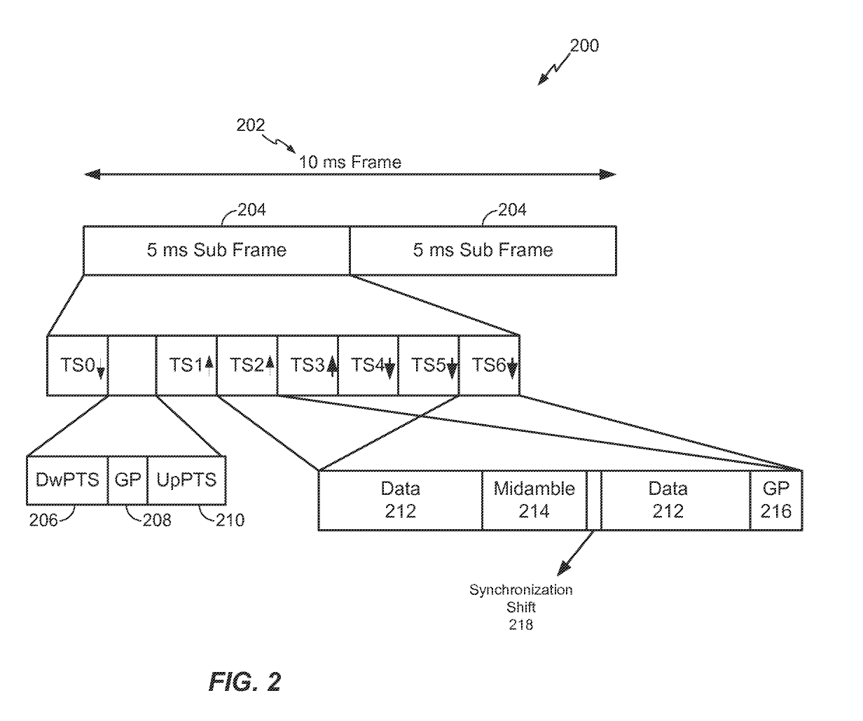

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

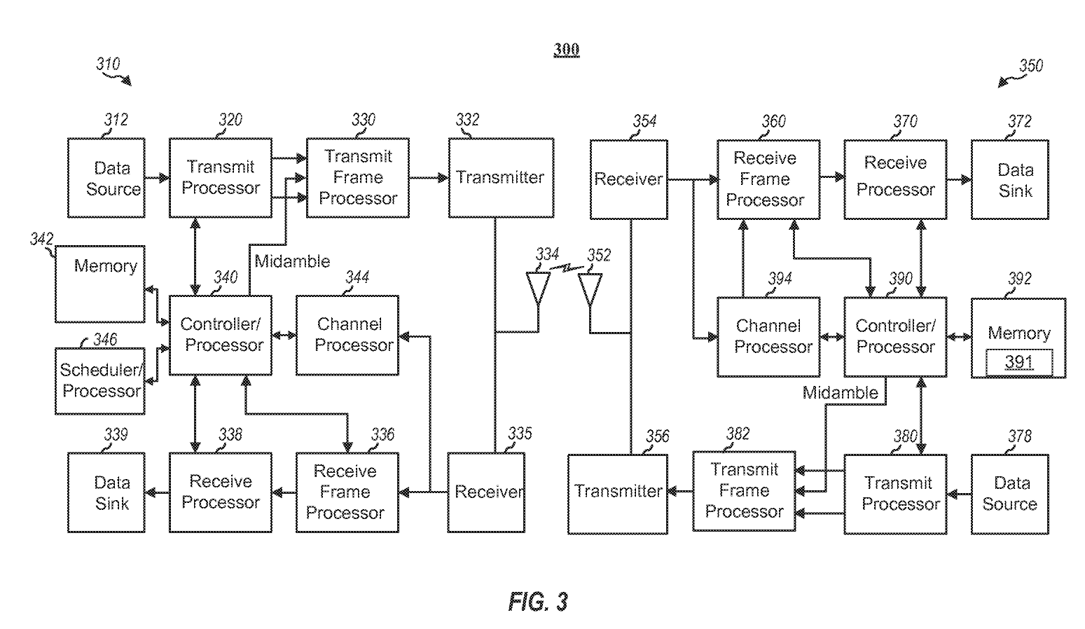

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store buffer size reporting module 391 which, when executed by the controller/processor 390, configures the UE 350 to report a buffer size, including a false buffer size.

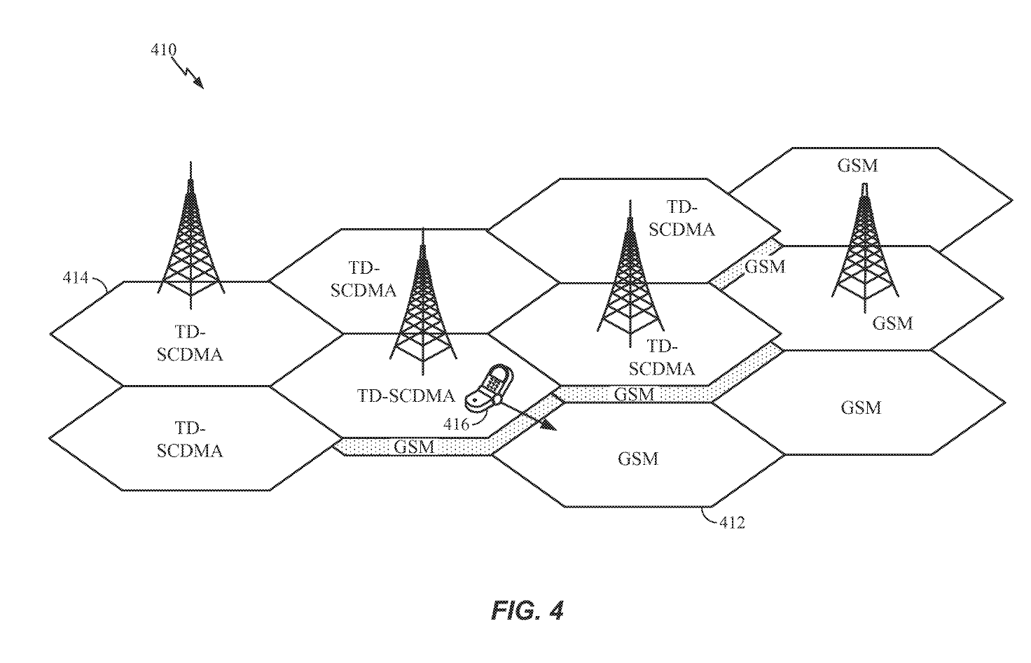

FIG. 4 illustrates coverage of a newly deployed network, such as a TD-SCDMA network and also coverage of a more established network, such as a GSM network. A geographical area 410 may include GSM cells 412 and TD-SCDMA cells 414. A user equipment (UE) 416 may move from one cell, such as a TD-SCDMA cell 414, to another cell, such as a GSM cell 412. The movement of the UE 416 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Handover of a UE from a serving RAT to a neighbor RAT may occur when the serving cell signal strength is below the serving system threshold. If a target GSM neighbor cell RSSI is above a neighbor system threshold, and the target GSM neighbor cell is identified and reconfirmed by network, the UE sends a measurement report to a serving cell which commences handover.

High speed uplink packet access (HSUPA) is an enhancement to TD-SCDMA, and is utilized to enhance uplink throughput. HSUPA introduces the following physical channels: enhanced uplink dedicated channel (E-DCH), E-DCH physical uplink channel (E-PUCH), E-DCH uplink control channel (E-UCCH), E-DCH random access uplink control channel (E-RUCCH), absolute grant channel for E-DCH and hybrid ARQ indication channel for E-DCH (E-HICH).

The E-DCH is a dedicated transport channel and may be utilized to enhance an existing dedicated channel (DCH) transport channel carrying data traffic. The E-PUCH carries E-DCH traffic and scheduling information (SI). The E-PUCH can be transmitted in burst fashion.

The E-UCCH carries Layer 1 information for E-DCH. The E-UCCH includes the uplink physical control channel and carries scheduling information (SI), including a scheduling request and the UE ID (i.e., enhanced radio network temporary identifier (E-RNTI).) The transport block size may be 6 bits and the retransmission sequence number (RSN) may be 2 bits. Also, the HARQ process ID may be 2 bits.

The E-RUCCH is an uplink physical control channel that carries scheduling information and enhanced radio network temporary identities ((E-RNTI) used for identifying the UEs. The E-AGCH carries grants for E-PUCH transmission, such as the maximum allowable E-PUCH transmission power, time slots, and code channels. Additionally, the E-HICH carries HARQ ACK/NAK signals.

In TD-HSUPA, the transmission of scheduling information (SI) may consist of in-band and out-band. The in-band type may be included in a medium access control e-type protocol data unit (MAC-e PDU) on the E-PUCH. The data may be sent standalone or may piggyback onto a data packet. For out-band, the data may be sent on the E-RUCCH. The scheduling information may include information, such as the highest priority logical channel ID (HLID), the total E-DCH buffer status (TEBS), the highest priority logical channel buffer status (HLBS) and the UE power headroom (UPH).

The HLID field identifies the highest priority logical channel with available data. If multiple logical channels exist with the highest priority, the one corresponding to the highest buffer occupancy is reported.

The TEBS field identifies the total amount of data available across all logical channels for which reporting has been requested by the radio resource control (RRC). The TEBS field also indicates the amount of data (in number of bytes) that is available for transmission and retransmission in the radio link control (RLC) layer. When the medium access control (MAC) is connected to an acknowledge mode (AM) radio link control entity, the control protocol data units (PDUs) that are to be transmitted and RLC PDUs outside the RLC transmission window are also included in the TEBS. The RLC PDUs that have been transmitted, but not negatively acknowledged by the peer entity, are not included in the TEBS. The actual value of the TEBS transmitted is one of 31 values that are mapped to a range of a number of bytes (e.g., 5 mapping to 24<TEBS<32).

The HLBS field indicates the amount of data available from the logical channel identified by the HLID. The amount of data available is relative to the highest value of the buffer size range reported by the TEBS when the reported TEBS index is not 31, and relative to 50,000 bytes when the reported TEBS index is 31. The values taken by HLBS is one of 16 values that map to a range of percentage values (e.g., 2 maps to 6%<HLBS<8%)

The UPH field indicates the ratio of the maximum UE transmission power and the corresponding dedicated physical control channel (DPCCH) code power. Further, the path loss information reports the path loss ratio between the serving cells and the neighbouring cells.

### Buffer Size Reporting for IRAT Measurements In TD-HSUPA

In the conventional approach, when the UE receives E-AGCH grants consecutively in every subframe, (for example during a file transfer protocol (FTP) upload), there are no idle slots available for IRAT measurement. Without sufficient time for a UE to perform IRAT measurements, a signal connection may continue to decrease in quality until the call is dropped, even when there are strong neighboring cells (such as GSM cells) available for potential handover.

One aspect of the present disclosure is directed to intelligently reporting buffer size in TD-HSUPA to create opportunities for IRAT measurements. In particular, when a TD-HSUPA signal connection is below a certain quality level, a UE may falsely report a buffer size, thereby creating communication gaps during which a UE may perform IRAT measurements.

For example, when the a TD-HSUPA serving cell primary common control physical channel (PCCPCH) received signal code power (RSCP) is below a predefined threshold, and/or the downlink (DL) traffic time slots signal to noise ratio (SNR) or signal to interference plus noise ratio ((SINR) are below a predefined threshold, the UE may determine to perform an IRAT measurement. When no time slots are available for IRAT measurement (for example, due to continuous E-AGCH grants), the UE may report an empty buffer to a serving base station, (i.e., TEBS=0 in SI carried in E-PUCH), even if the UE's actual buffer size is not zero. In response to receiving an indication of a zero buffer, the serving node B stops sending E-AGCH grants, thereby creating idle time slots for the UE. The data that remains in the UE buffer may then be sent at a later time to a new serving base station (post-handover) or to the existing base station (should handover not happen and/or communication conditions improve).

The UE can then use time slots that would otherwise have been reserved for E-PUCH or E-HICH (Enhanced Hybrid ARQ Indicator Channel) communications, and other existing idle time slots, to perform RAT measurements. The IRAT measurements may include, for example, measuring GSM received signal strength indication (RSSI) frequency correction channel (FCCH) detection, and synchronization channel base station identity code (SCH BSIC) confirmation and reconfirmation.

This proposed method may reduce undesired call drops by allowing time for a UE to perform IRAT measurements, thereby leading to a more efficient IRAT handover to other RATs.

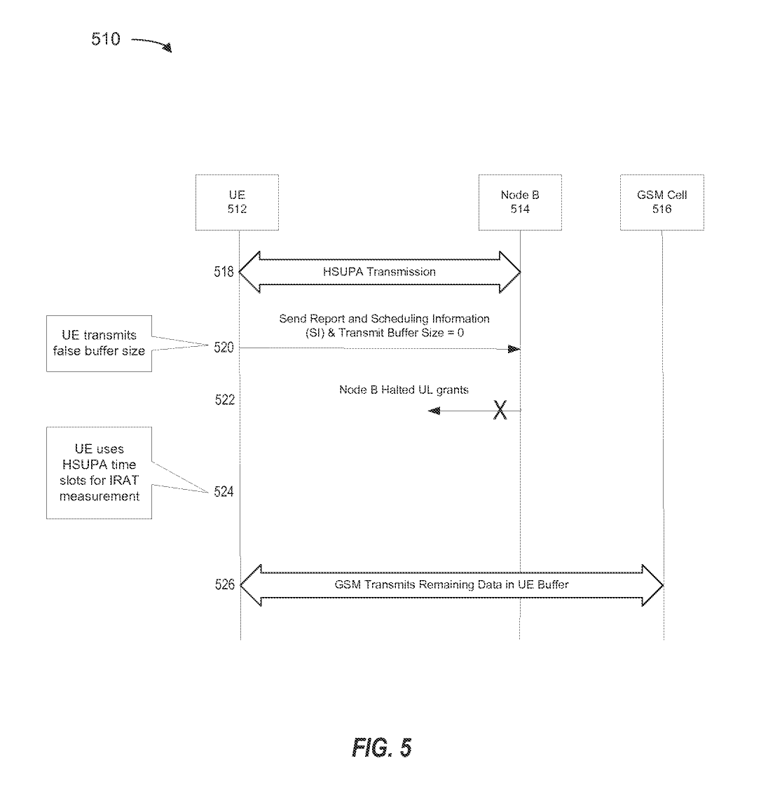

FIG. 5 is a call flow diagram 510 illustrating the reporting of buffer size according to one aspect of the present disclosure. Illustrated are a UE 512, node B 514 and GSM cell 516. At time 518, the UE 512 and the node B cell 514 engage in HSUPA transmission. If the UE determines that the HSUPA communication quality is dropping below a certain level and the UE desires additional time slots to perform IRAT measurements, at time 520, the UE 512 sends the node B 514 a report containing scheduling information (SI) and transmits information stating that the buffer size is equal to zero, even if the buffer may actually not be empty. Therefore, the real buffer size is not reported and a false one (a buffer size of zero) is reported instead. At time 522, the node B cell 514 halts uplink grants because it believes that the UE 512 has no data due to the false buffer size report of zero sent by the UE 512. At time 524, the UE 512 uses the time slots that otherwise would have been used for HSUPA communications for IRAT measurement of another cell, such as the GSM cell 516. Should handover occur, at time 526, the UE 512 may transmit to the new serving base station (such as GSM cell 516) the remaining data in the UE buffer.

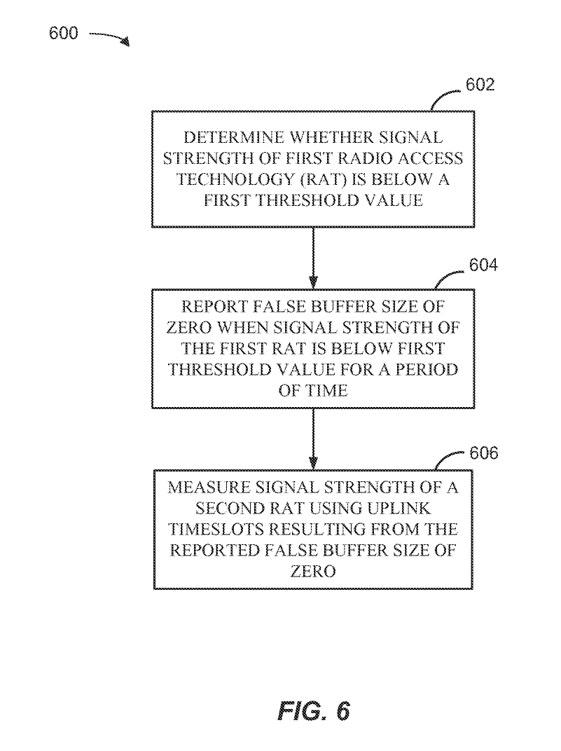

FIG. 6 shows a wireless communication method 600 according to one aspect of the disclosure. In block 602, a UE determines whether a signal strength of a first radio access technology (RAT) is below a first threshold value. In block 604, the UE reports a false buffer size of zero when the signal strength of the first RAT is below the first threshold value for a period of time. In box 606, the UE measures a signal strength of a second RAT using uplink timeslots resulting from the reported false buffer size of zero.

In one configuration, an actual buffer size is reported when the signal strength of the first RAT exceeds the first threshold value. In one configuration, an actual buffer size is reported after handing over to the second RAT. In one configuration, the signal strength of a target cell is measured. Then the buffer size is modified when the signal strength of the target cell is above the first threshold value. The modified buffer size is then reported. In one configuration, the signal strength of a serving cell is measured. Then the buffer size is modified when the signal strength of the serving cell is below the first threshold value. The modified buffer size is then reported. In one configuration, the reporting of the modified buffered size is stopped after the occurrence of an event, the event including at least one of when the signal strength of the first RAT exceeds the first threshold value or hand over to the second RAT occurs. Then an actual buffer size is reported.

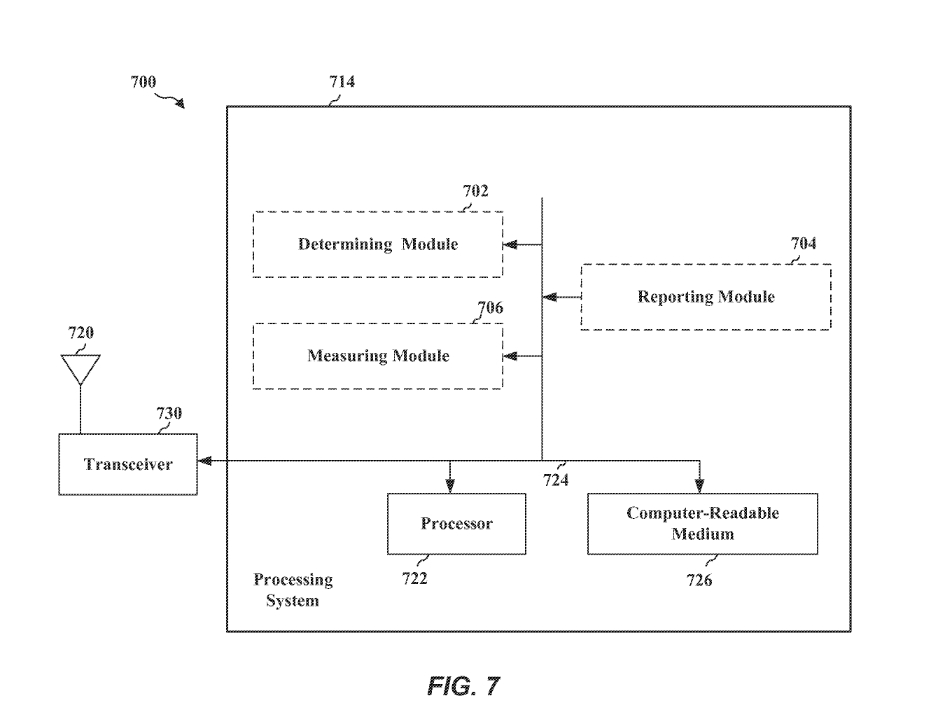

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, the determining module 702, the reporting module 704, the measuring module 706 and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a determining module 702 for determining whether a signal strength of a first RAT is below a threshold value, a reporting module 704 for reporting a false buffer size of zero when the signal strength is below the threshold value for a period of time and a measuring module 706 for measuring a signal of a second RAT using uplink timeslots resulting from the false buffer size of zero. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for determining In one aspect, the determining means may be the controller/processor 390, the memory 392, and/or the determining module 702 configured to perform the functions recited by the aforementioned means. The UE is also configured to include means for reporting. In one aspect, the reporting means may be the antennas 352, the transmitter 356, the transmit processor 380, the controller/processor 390, the memory 392, the buffer size reporting module 391, the reporting module 704, and/or the processing system 714 configured to perform the functions recited by the aforementioned means. The UE is also configured to include means for measuring. In one aspect, the measuring means may be the controller/processor 390, the memory 392 and/or the measuring module 706 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a signal strength of a first radio access technology (RAT) is below a first threshold value;
reporting a false buffer size of zero when the signal strength of the first RAT is below the first threshold value for a period of time; and
measuring a signal strength of a second RAT using uplink timeslots resulting from the reported false buffer size of zero.

2. The method of claim 1, further comprising reporting an actual buffer size when the signal strength of the first RAT exceeds the first threshold value.

3. The method of claim 1, further comprising reporting an actual buffer size after handing over to the second RAT.

4. The method of claim 1, in which measuring the signal strength of the second RAT is determined based at least in part on one of:
comparing a primary common control physical channel (P-CCPCH) received signal code power (RSCP) to a second threshold value;
comparing a downlink (DL) traffic time slot signal to noise ratio (SNR) or signal to interference plus noise ratio (SINR) to a third threshold value; and
comparing a transmission (TX) power to a fourth threshold value.

5. The method of claim 1, further comprising:
communicating with the first RAT;
discarding an uplink grant based at least in part on a signal quality of the first RAT, the uplink grant corresponding to at least one uplink timeslot overlapping with a measurement signal from the second RAT; and
performing measurement of the second RAT during the at least one uplink timeslot.

6. The method of claim 1, further comprising:
measuring a signal strength of a target cell;
modifying the buffer size when the signal strength of the target cell is above the first threshold value; and
reporting the modified buffered size.

7. The method of claim 6, further comprising:
measuring a signal strength of a serving cell;
modifying the buffer size when the signal strength of the serving cell is below the first threshold value; and
reporting the modified buffered size.

8. The method of claim 7, further comprising:
stopping the reporting of the modified buffered size after an occurrence of an event, the event including at least one of when the signal strength of the first RAT exceeds the first threshold value or hand over to the second RAT occurs; and
reporting an actual buffer size.

9. An apparatus for wireless communication, comprising:
a memory; and
at least one processor coupled to the memory, the at least one processor being configured:
to determine whether a signal strength of a first radio access technology (RAT) is below a first threshold value;
to report a false buffer size of zero when the signal strength of the first RAT is below the first threshold value for a period of time; and
to measure a signal strength of a second RAT using uplink timeslots resulting from the reported false buffer size of zero.

10. The apparatus of claim 9, in which the at least one processor is further configured to report an actual buffer size when the signal strength of the first RAT exceeds the first threshold value.

11. The apparatus of claim 9, in which the at least one processor is further configured to report an actual buffer size after handing over to the second RAT.

12. The apparatus of claim 9, in which the at least one processor configured to measure based at least in part on at least one of:
comparing a primary common control physical channel (P-CCPCH) received signal code power (RSCP) to a second threshold value;
comparing a downlink (DL) traffic time slot signal to noise ratio (SNR) or signal to interference plus noise ratio (SINR) to a third threshold value; and
comparing a transmission (TX) power to a fourth threshold value.

13. The apparatus of claim 9, in which the at least one processor is further configured:
to communicate with the first RAT;
to discard an uplink grant based at least in part on a signal quality of the first RAT, the uplink grant corresponding to at least one uplink timeslot overlapping with a measurement signal from the second RAT; and
to perform measurement of the second RAT during the at least one uplink timeslot.

14. The apparatus of claim 9, in which the at least one processor is further configured:
to measure a signal strength of a target cell;
to modify the buffer size when the signal strength of the target cell is above the first threshold value; and
to report the modified buffered size.

15. The apparatus of claim 14, in which the at least one processor is further configured:
to measure a signal strength of a serving cell;
to modify the buffer size when the signal strength of the serving cell is below the first threshold value; and
to report the modified buffered size.

16. The apparatus of claim 15, in which the at least one processor is further configured:
to stop the reporting of the modified buffered size after an occurrence of an event, the event including at least one of when the signal strength of the first RAT exceeds the first threshold value or hand over to the second RAT occurs; and
to report an actual buffer size.

17. An apparatus for wireless communication, comprising:
means for determining whether a signal strength of a first radio access technology (RAT) is below a first threshold value;
means for reporting a false buffer size of zero when the signal strength of the first RAT is below the first threshold value for a period of time; and
means for measuring a signal strength of a second RAT using uplink timeslots resulting from the reported false buffer size of zero.

18. The apparatus of claim 17, further comprising means for reporting an actual buffer size when the signal strength of the first RAT exceeds the first threshold value.

19. A computer program product for wireless communication in a wireless network, comprising:
a non-transitory computer-readable medium having non-transitory program code recorded thereon, the program code comprising:
program code to determine whether a signal strength of a first radio access technology (RAT) is below a first threshold value;
program code to report a false buffer size of zero when the signal strength of the first RAT is below the first threshold value for a period of time; and
program code to measure a signal strength of a second RAT using uplink timeslots resulting from the reported false buffer size of zero.

20. The computer program product of claim 19, further comprising program code for reporting an actual buffer size when the signal strength of the first RAT exceeds the first threshold value.
